(19) United States
(12) Patent Application Publication
(10) Pub. No.: US 2008/0077968 A1
(43) Pub. Date: Mar. 27, 2008

(54) Receiver and multiple receiver apparatus

(75) Inventor: Mitsutoshi Okami, Kashiba-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/878,548

(22) Filed: Jul. 25, 2007

(30) Foreign Application Priority Data
Sep. 27, 2006 (JP) 2006-263543

(51) Int. Cl. H04N 5/44

(52) U.S. Cl. 725/151

(57) ABSTRACT

A receiver includes a tuner chassis and a substrate provided inside the tuner chassis so as to allow a high frequency signal to flow therein, wherein an input cable whose frame connection section is provided around a signal line. A connector for allowing connection with the input cable is provided on the substrate and an opening which allows the input cable to pass therethrough is provided in the tuner chassis. A GND connection section for connecting the frame connection section of the input cable to the tuner chassis is provided on the opening, and the tuner chassis and an earthing conductor of the substrate can be connected via an earthing conductor of the input cable extending from the cable GND connection section to the connector. As a result, it is possible to surely shield the signal line, the receiving circuit substrate, and a ground of the receiver with a shortest distance, thereby shutting out an unnecessary signal.

This Nonprovisional application claims priority under U.S.C. §119(a) on Patent Application No. 263543/2006 filed in Japan on Sep. 27, 2006, the entire contents of which are hereby incorporated by reference.

### FIELD OF THE INVENTION

The present invention relates to a cable connection section used in a receiver for transmitting/receiving a high frequency signal, e.g., a broadcast signal receiver. Particularly, the present invention relates to (i) a cable connection section of each of receivers such as a tuner used for signal transmission and reception in a television, video cassette recorder, or a set top box and the like and (ii) a cable connection section of a multiple receiver apparatus including the foregoing receivers in plurality.

### BACKGROUND OF THE INVENTION

A ground wave tuner used for a television picks up a signal having a desired frequency from a signal caught by an antenna.

In a conventional ground wave tuner, an RF input signal is inputted via an input cable extended from an antenna into an RF input terminal fixed on a tuner chassis.

FIG. 10 is a plan view illustrating a conventional connection section which allows an input cable extended from an antenna and a tuner to be connected to each other. This shows that an input cable 120 extended from the antenna and a tuner chassis 130 are connected to each other by an antenna input connectors 110 and 121.

As shapes of the antenna input connectors 110 and 120, an IEC connector (female type), an F connection plug (male type), an RCA phonojack, and the like are widely known.

The tuner is arranged so that a signal line and the tuner are shielded and are connected to a ground so as to shut out an unnecessary signal, thereby preventing an external signal or interference with an internal signal from influencing the RF input signal and the like.

For example, Patent Document 1 (Japanese Unexamined Patent Publication No. 60474/2006 (Tokukai 2006-60474)(Publication date: Mar. 2, 2006) discloses an arrangement in which: in order to prevent signals of an analog signal circuit and a digital signal circuit (RF signal circuits) from mutually influencing each other due to radiation thereof, the analog circuit is covered by a shield case and then the shield-case-covered analog circuit and the digital circuit processing a digital signal are covered by other shield case.

Recently, size reduction of the tuner is likely to result in an arrangement in which an RF output connector for externally outputting an RF signal from the tuner is provided or an arrangement in which two or more tuners are provided in a single housing.

If a large number of RF input/output connectors are provided as described above, the RF input/output connectors 110 provided on the tuner chassis 130 occupy a large space. Particularly in case of connecting a plurality of tuners, the RF signal input connector 110 externally protruding from the tuner chassis 130 (i.e., a receiving side connector) makes it impossible to reduce the size of the apparatus.

As a trial to reduce the size of the input connector, Patent Document 2 (Japanese Unexamined Patent Publication No. 55209/2004 (Tokukai 2004-55209)(Publication date: Feb. 19, 2004) discloses an arrangement in which the input connector is partially or entirely provided inside the tuner chassis 130.

Further, in a small size tuner, as illustrated in FIG. 11, an input terminal 110a constituted of pins having the same shape as a power source connector is used so as to allow the RF input signal to be inputted.

However, each of the conventional arrangements raises such a problem that: it is impossible to surely shield grounds of a signal line, a receiving circuit substrate, and a receiver with a shortest distance so as to shut out an unnecessary signal.

Patent Document 2 discloses the arrangement in which the input connector 110 is partially or entirely positioned inside the tuner chassis 130 for smaller size of the input connector.

According to the arrangement of Patent Document 2, the input connector 110 is provided on the tuner chassis 130, so that it is necessary to greatly change a shape of the tuner chassis 130 and to internally bend the input connector 110 in order that the input connector 110 is partially or entirely positioned inside the tuner chassis 130.

However, according to the arrangement, the input connector 110 is provided on the tuner chassis 130, so that the input cable 120 extended from the antenna and the tuner chassis 130 are connected to the ground, but it is necessary to additionally connect the receiving circuit substrate and the tuner chassis 130 to the ground.

Further, if any grounding potential deviation occurs in (i) the input cable 120 extended from the antenna, (ii) the tuner chassis 130, (iii) and the receiving circuit substrate, due to unstable grounding or long distance grounding, less effective shielding results in radiation of an unnecessary signal, or outside radiation is likely to have any influence.

The present invention was made in view of the foregoing problems, and an object of the present invention is to provide a receiver and a multiple receiver apparatus in which a ground of each of a signal line, a receiving circuit substrate, and a receiver is surely shielded with a shortest distance so as to shut out an unnecessary signal.

### SUMMARY OF THE INVENTION

In order to solve the foregoing problems, a receiver of the present invention including: a conductive frame; and a circuit substrate which is provided inside the conductive frame and allows a high frequency signal to flow therein, one or more cables each of which has one or more earthing conductors provided around a signal line being connected to the circuit substrate, said receiver comprising: one or more connectors provided on the circuit substrate so as to allow connection with the cable; and one or more connection sections respectively provided on one or more openings, each of which is provided in the conductive frame and allows the cable to pass therethrough, so that the connection section is in contact with the earthing conductors of the cable connected to the connector so as to connect the earthing conductors to the conductive frame, wherein the conductive frame and an earthing conductor of the circuit substrate are connectable via the earthing conductors extending from the connection section to the connector.

Further, it is preferable to arrange the receiver of the present invention so that the conductive frame serves as a chassis.

According to the foregoing arrangement, the cable having the earthing conductor allows the earthing conductor of the circuit substrate provided inside the conductive frame to be connected to the conductive frame. Such connection allows the conductive frame and the circuit substrate to be connected with a shortest distance.

That is, grounding potentials can be kept the same in the earthing conductors of the circuit substrate, the conductive frame, and the cable, so that it is possible to more efficiently shut out radiation and external noise.

Further, the signal receiving line of the receiver is connected directly to the circuit substrate provided inside the receiver, so that it is possible to reduce the size of the receiver.

### BRIEF DESCRIPTION OF THE DRAWINGS

FIG. 1 is a cross sectional view illustrating one embodiment of a receiver of the present invention so as to show a state in which an RF signal input connector of the receiver is provided on a receiver substrate, and a GND of the receiver substrate and a GND of a tuner chassis are connected to each other by a GND line of an input cable of the receiver.

FIG. 2 is a cross sectional view illustrating other embodiment of the receiver of the present invention so as to show a state in which the input cable is connected from a shield cover side of the receiver unlike the arrangement of FIG. 1.

FIG. 3 is a cross sectional view illustrating other embodiment of the receiver of the present invention so as to show a state in which the input cable of the receiver is connected from the shield cover side of the receiver as in the arrangement of FIG. 2 and a GND line of the input cable of the receiver is connected to the shield cover, and the shield cover is connected to the tuner chassis.

FIG. 4 is a cross sectional view illustrating other embodiment of the receiver of the present invention so as to show a state in which a GND terminal of the RF signal input connector of the receiver is connected to the tuner chassis unlike the arrangement of FIG. 1.

FIG. 5 is a cross sectional view illustrating other embodiment of the receiver of the present invention so as to show a state in which the GND terminal of the RF signal input connector of the receiver is connected to the shield cover unlike the arrangement of FIG. 1.

FIG. 6 is a cross sectional view illustrating other embodiment of the receiver of the present invention so as to show a state in which a connector frame connection section is formed on the GND line of the input cable of the receiver, and the RF signal input connector of the receiver and a GND connector of the tuner chassis are connected by the connector frame connection section provided on the input cable unlike the arrangement of FIG. 1.

FIG. 7 is a block diagram illustrating other embodiment of the receiver of the present invention so as to show a state in which a plurality of receivers of the present invention are connected.

FIG. 8 is a cross sectional view illustrating other embodiment of the receiver of the present invention so as to show a state in which each of the plural receivers of the present invention is arranged as illustrated in FIG. 7 and these receivers are stored in the chassis.

FIG. 9 is a cross sectional view illustrating a conventional receiver so as to show a state in which a plurality of receivers having conventional RF signal input/output connectors are connected as illustrated in FIG. 7 and the receivers are stored in a chassis.

FIG. 10 is a plan view illustrating a conventional receiver.

FIG. 11 is a plan view illustrating other conventional receiver.

### DESCRIPTION OF THE EMBODIMENTS

The present invention relates to (i) a tuner terminal which is provided on a tuner having a tuner chassis so that RF signal input/output terminals are provided on a substrate disposed inside the tuner so as to further reduce a size of the input/output terminal section and (ii) a receiver including the tuner terminal. In connecting the RF input/output terminal to an RF signal input/output cable, a GND line surrounding a cable signal line is connected to the tuner chassis, so that GNDs of the input/output cable and the tuner substrate are connected to the tuner chassis with a short distance, thereby more effectively shutting out any radiation or external noise. According to the arrangement, it is possible to more efficiently shut out any RF signal radiation and external signal.

### Embodiment 1

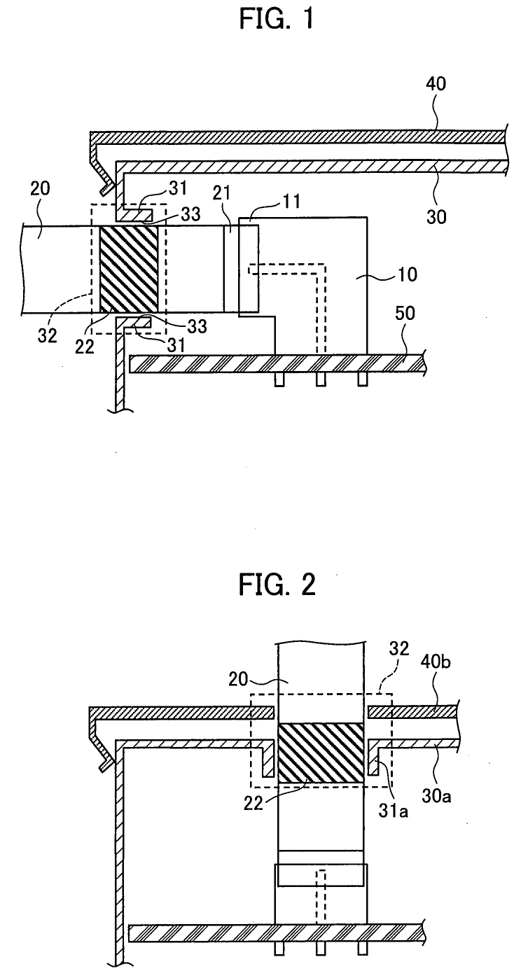

The following describes an embodiment of the present invention with reference to FIGS. 1 to 6.

FIG. 1 is a cross sectional view illustrating part of an input cable, an RF signal input terminal, and a tuner chassis of the present embodiment.

A substrate 50 is installed on a tuner chassis 30, and an RF signal input connector 10 is provided on the substrate 50. Further, a shield cover 40 is provided outside the tuner chassis 30.

In the present embodiment, an RF signal input cable 20 is connected to the RF signal connector 10. At this time, a GND line of the input cable 20 is connected to a GND 11 of the connector 10, i.e., a ground line of the substrate 10, by a GND connection section 21, and the GND line is connected to a cable GND connection section 31 of the tuner chassis 30 by the frame connection section 22.

In order to insert the input cable 20 into the tuner chassis 30, an opening 32 is provided in the tuner chassis 30. Further, in order to connect the GND line of the input cable 20 to the tuner chassis 30, a cable GND connection section 31 is provided on the opening 32. In the present embodiment, the cable GND connection section 31 has a substantially cylindrical shape extending along an external shape of the input cable 20 into the tuner chassis 30. Further, it is preferable that the cable GND connection section 31 has elasticity so as to be pressed against the frame connection section 22 of the input cable 20.

According to the conventional arrangement, the input terminal is provided on the tuner chassis, so that it is necessary to bend a part of the tuner chassis close to the substrate of the tuner in reducing a size of the input terminal portion of the tuner. Therefore, in order to keep effectively shutting out an external signal or an internal signal, it is necessary to suitably study a layout of the tuner chassis structure and the tuner substrate.

In the present embodiment, the connector 10 is provided on the substrate 50 provided inside the tuner chassis 30 so as to prevent the connector 10 from protruding from an external face of the tuner chassis 30. As a result, it is possible to reduce a space where the tuner is installed. Further, the GND of the substrate 50 and the tuner chassis 30 (cable GND connection section 31) are connected to each other by the GND line of the input cable 20 connected to the connector 10 of the substrate 50. Thus, the GND of the substrate 50 and the tuner chassis 30 can be surely connected to each other with a short distance. As a result, the signal line and the tuner are shielded, thereby shutting out an unnecessary signal. Further, the input cable 20 has a portion positioned in a vicinity of a connection point between the input cable 20 and the connector so that the portion is supported by the cable GND connection section 31 of the tuner chassis 30, so that the input cable 20 and the connector 10 are stably connected to each other.

Further, the cable GND connection section 31 may include a pressure section 33 formed by using an elastic member such as a spring and supporting the input cable 20. This arrangement allows the frame connection section 22 of the input cable 20 to be stably in contact with the cable GND connection section 31 of the tuner chassis when plugging in or off the input cable 20.

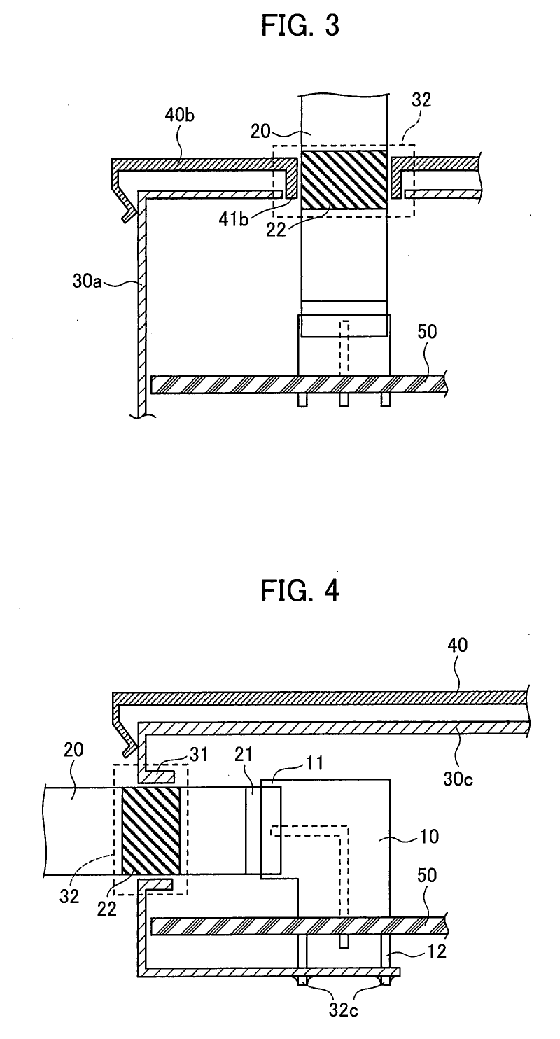

Note that, in case of connecting the input cable 20 from the shield cover side in an inserting direction of the input cable 20, a cable GND connection section 31a may be provided on a tuner chassis 30a as illustrated in FIG. 2, or a cable GND connection section 41b may be provided on a shield cover 40b as illustrated in FIG. 3. In either case, it is possible to realize (i) a function for supporting the input cable 20 and (ii) a function for connecting the input cable 20 to the GND tuner chassis of the tuner substrate 50 with a short distance so as to enhance the GND performance.

Note that, it is general that the shield cover is more elastic than the chassis as a spring, so that a contacting strength of the shield cover is less likely to be dropped by plugging in/off the input cable 20.

Further, FIG. 4 illustrates an example in which the connection of the GND is further enforced. In this example, a connection terminal 12 of the GND of the connector 10 installed on the substrate 50 is extended so as to be connected to a tuner chassis 30c disposed on a rear side of the substrate 50.

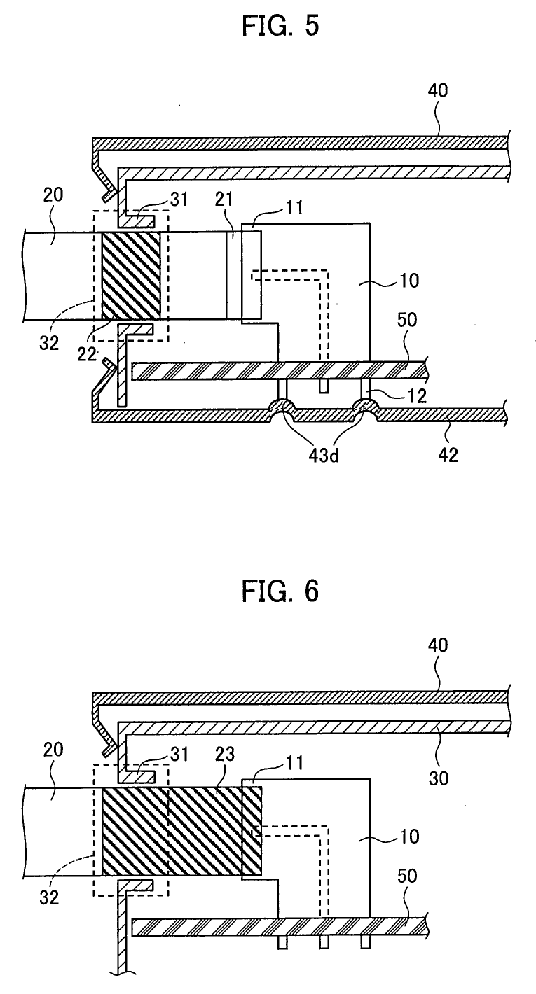

Further, FIG. 5 illustrates an arrangement in which the connection terminal 12 of the GND of the connector 10 installed on the substrate 50 is extended so as to be in contact with the shield cover 42 positioned on the rear side of the substrate 50.

The connection terminal 12 of the GND of the connector 10 may be connected as follows: holes are provided in the tuner chassis 30c or the shield cover 42, and the GND connection terminal 12 is inserted into each of the holes 32c or 43d and caulked. Alternatively, the connection terminal 12 of the GND of the connector 10 may be connected as follows: the GND connection terminal 12 inserted into each of the holes 21c or 43d in the same manner is soldered. Further, it may be so arranged that: the GND connection terminal 12 of the connector 10 which allows connection with the substrate 50 is formed as a terminal using a spring, and the GND connection terminal 12 formed in this manner is brought into contact with the tuner chassis 30c or the shield cover 42 positioned in the rear side of the substrate 50, thereby connecting the GND connection terminal 12.

According to the arrangement, the GND of the connector 10 is directly in contact with the tuner chassis 30c or the shield cover 42, so that the GND is more firmly connected.

Note that, in the above-described embodiment, the connector GND connection section 21 and the frame connection section 22 are formed on the GND line of the RF signal input cable 20 and are connected to the GND terminal of the connector 10 and the cable GND connection section 31 of the tuner chassis 30. However, as illustrated in FIG. 6, the connection sections 21 and 22 may be integrally formed as a connector/frame connection section 23 so as to be connected to the GND terminal 11 and the cable GND connection section 31.

In forming the connector/frame connection section 23, the GND line of the input cable 20 may be used without any modification or may be formed as a metallic terminal. The connector/frame connection section 23 is formed as the metallic terminal, so that it is possible to realize firmer connection without dropping the strength of the input cable 20 in plugging in/off the input cable 20 and without dropping the contacting strength between (i) the frame/connector 23 and the GND terminal 11 and (ii) the cable GND connection section 31.

### Embodiment 2

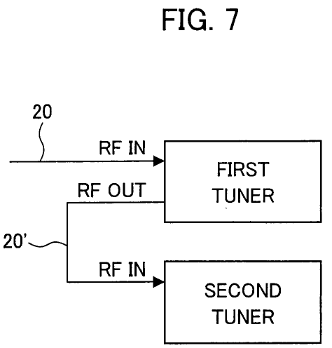

The following describes other embodiment of the present invention with reference to FIGS. 7 to 9. Note that, an arrangement of the present embodiment is the same as the arrangement of Embodiment 1 except for the below-described points. Further, for convenience in description, the same reference numerals are given to members having the same functions as the members described in the drawings of Embodiment 1, and descriptions thereof are omitted.

In the present embodiment, an arrangement in which a plurality of the tuners of Embodiment 1 are provided will be explained.

Recently, each of a television, a video cassette recorder, and a set top box serving as a device connected to a television so as to allow reception of various kinds of information service is likely to be smaller. Further, among the foregoing devices, there are some devices each of which has a plurality of tuners. Also there are some flat type televisions each of which has two ground wave tuners.

FIG. 7 is a block diagram illustrating a state in which: a signal inputted via a single input cable is inputted to a first tuner, and the signal is further inputted from the first tuner to a second tuner via an input cable 20′. As such a tuner, there are known (i) a tuner having a loop-through function for outputting an input signal from an antenna without any modification and (ii) a tuner having an off-through function for outputting an input signal from an antenna even at the time of power-off. The first tuner illustrated in FIG. 7 may be the tuner having the loop-through function or the off-through function. Alternatively, the first tuner may be arranged so that the aforementioned functions are not provided and also the first tuner is operated while a second tuner is used.

In the present embodiment, the cable connection method described in Embodiment 1 is adopted to an RF signal input/output connector section of the first tuner and an RF signal input connector section of the second tuner.

According to the arrangement, the RF signal output connector of the first tuner and the RF signal input connector of the second tuner are respectively provided on substrates in the tuners so that these input/output connectors do not protrude from the tuner chassis, and the GND line surrounding a signal line of the input cable 20′ is connected to the tuner chassis, so that the substrates of the first and second tuners have the same potential as the GND of the tuner chassis. That is, in the first and second tuners, a stable GND shared by both the tuners can be used, so that it is possible to effectively shield the input cable 20′ connecting the first and second tuners from unnecessary RF signal radiation and an external signal.

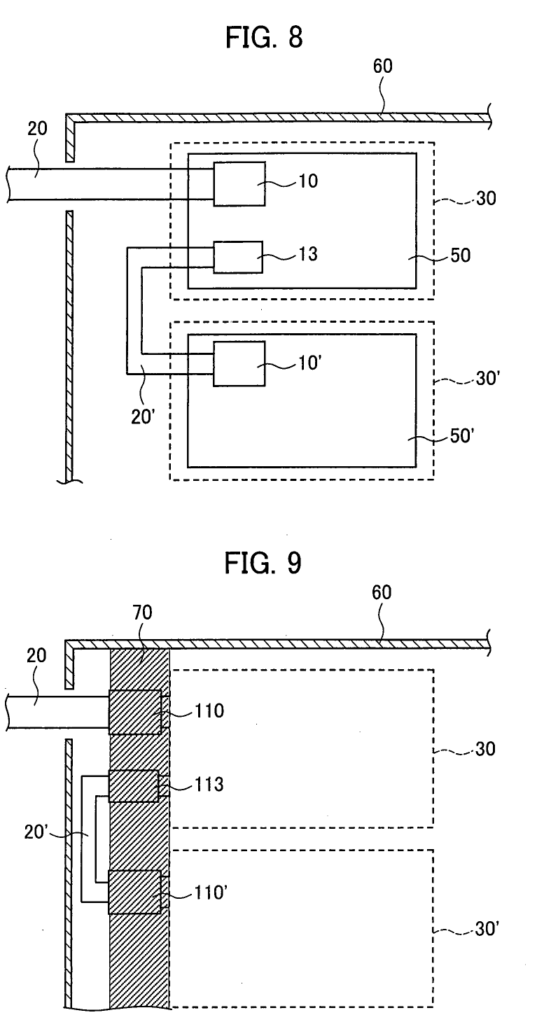

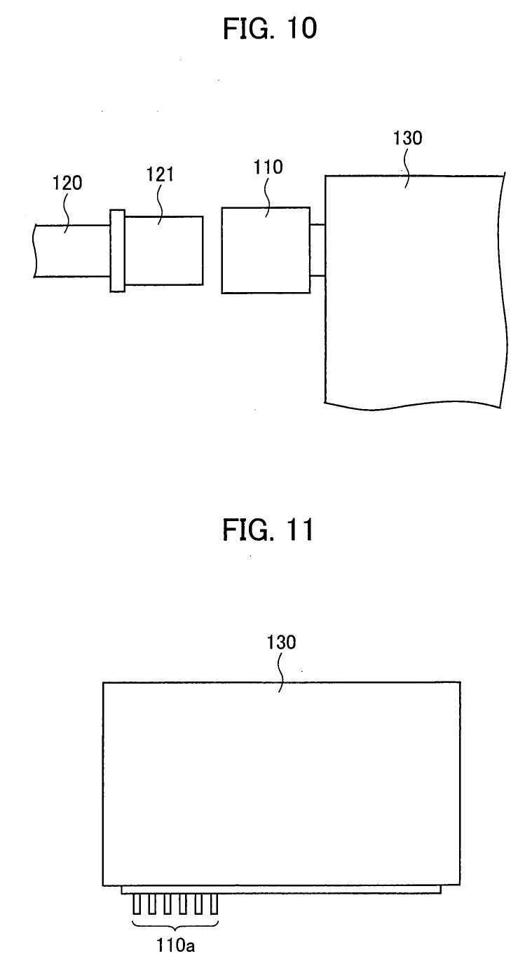

FIG. 8 is a cross sectional view illustrating a state in which the first and second tuners of the present embodiment are provided in a chassis 60. The first and second tuners are respectively covered by the tuner chassis 30 and the tuner chassis 30′. An arrangement of FIG. 8 is a specific example of the arrangement of FIG. 7. In FIG. 8, the RF signal input connector which allows connection with the input cable 20 is provided on the first tuner, and an RF signal input connector 10′ of the second tuner is connected to the output connector 13 of the first tuner by the input cable 20′. Further, the RF output connector section of the first tuner and the RF input connector section of the second tuner are connected to each other as illustrated in FIG. 7, and the cable connection method described in Embodiment 1 is adopted to the RF signal input/output connectors.

According to the arrangement illustrated in FIG. 8, the output connector 13 and the input connector 10′ of the respective tuners are not exposed to the outside of the tuner chassis, so that it is possible to prevent the input/output connectors from occupying a large space inside the chassis 60.

FIG. 9 is a cross sectional view of a chassis provided by using conventional RF signal input/output connectors and arranged in the same manner as in FIG. 8. The RF signal input/output connectors are 110, 113, and 110′ respectively.

In case of using the conventional RF signal input/output connectors 110, 113, and 110′ as all the RF signal input/output connectors, the conventional input/output connectors 110, 113, and 110′ are provided on the tuner chassis 30 and 30′ of the tuners respectively. Thus, as illustrated in FIG. 9, it is necessary to prepare a space in the chassis 60 in order to prepare connection sections of the RF signal input/output connectors.

While, when the RF signal output connector 13 of the first tuner and the RF signal input connector 10′ of the second tuner are connected to each other as in the present embodiment, it is possible to prevent the RF signal output connector 13 and the RF signal input connector 10′ from protruding from the tuner chassis 30 and 30′ respectively. Thus, it is not necessary to prepare a space for the connector section of the input cable 20 allowing connection of the first and second tuners in the chassis unlike the arrangement of FIG. 9.

That is, according to the present embodiment, unlike the case of using the conventional RF signal input/output connectors 110, 113, and 110′, it is not necessary to prepare a space for the RF signal input/output connectors (a shaded area illustrated in FIG. 9) in the chassis 60.

Further, the GND line surrounding the signal line of the input cable 20′ which connects the first and second tuners to each other allows GND connection of the substrates 50 and 50′ and the tuner chassis 30 and 30′ with short distances, so that it is possible to more effectively shut out RF signal radiation and an external signal.

Note that, FIG. 8 illustrates the input connector 10 of the present invention as the RF signal input terminal section of the first tuner, but it is needless to say that a conventional connector may be used as the RF signal input terminal section or a structure of the terminal may be suitably changed so as to correspond to a device to which the terminal is connected.

That is, the tuner terminal of the present invention is provided on the substrate inside the tuner chassis and a GND line of each of input/output cables allows each of the input/output cables for the tuner to be connected to a GND of the substrate and a GND of the tuner chassis with a short distance. According to the arrangement, it is possible to further reduce a size of the input/output terminal section and shield the signal line and the tuner, thereby shutting out an unnecessary signal. Particularly in case where a plurality of tuners are connected to one another, it is possible to effectively shut out unnecessary signal radiation caused by the connection cable and an unnecessary signal and also it is possible to reduce a necessary space.

Note that, the present invention is not limited to the description of the embodiments above, but may be altered by a skilled person within the scope of the claims. An embodiment based on a proper combination of technical means disclosed in different embodiments is encompassed in the technical scope of the present invention.

As described above, a receiver of the present invention including: a conductive frame; and a circuit substrate which is provided inside the conductive frame and allows a high frequency signal to flow therein, one or more cables each of which has one or more earthing conductors provided around a signal line being connected to the circuit substrate, said receiver comprising: one or more connectors provided on the circuit substrate so as to allow connection with the cable; and one or more connection sections respectively provided on one or more openings, each of which is provided in the conductive frame and allows the cable to pass therethrough, so that the connection section is in contact with the earthing conductors of the cable connected to the connector so as to connect the earthing conductors to the conductive frame, wherein the conductive frame and an earthing conductor of the-circuit substrate are connectable via the earthing conductors extending from the connection section to the connector.

Further, as described above, a multiple receiver apparatus of the present invention includes a plurality of receivers each of which is capable of inputting a high frequency signal from its outside and outputting the high frequency signal from its inside, wherein a connector provided on a first receiver so as to output the high frequency signal and a connector provided on a second receiver so as to input the high frequency signal are connected to each other by the cable.

According to the receiver of the present invention or the multiple receiver apparatus of the present invention, the erathing conductor of the circuit substrate provided inside the conductive frame is connected to the conductive frame by the cable having the earthing conductor. Such connection allows the conductive frame and the circuit substrate to be connected to each other with a short distance.

That is, grounding potentials can be kept the same in the circuit substrate, the conductive frame, and the earthing conductor of the cable. Further, in case of connecting the plurality of receivers, grounding potentials can be kept the same between the receivers. Thus, it is possible to more effectively shut out radiation and an external noise.

Further, the receiving signal line of the receiver is connected directly to the circuit substrate provided inside the receiver, so that it is possible to reduce a size of the receiver.

Therefore, it is possible to provide the receiver and the multiple receiver apparatus in which grounds of the signal line, the receiving circuit substrate, and the receiver are surely shielded so as to shut out an unnecessary signal.

Further, it is preferable to arrange the receiver of the present invention so that the conductive frame includes a chassis and a shielding member provided outside the chassis and electrically connected to the chassis, and the connection section is formed on the shielding member.

The shielding member is more elastic than the chassis, so that its contacting strength is less likely to be dropped by plugging off/in the cable.

Further, it is preferable to arrange the receiver of the present invention so that an earth terminal provided on the connector so as to allow connection of the connector and the circuit substrate is extended and is connected to the conductive frame.

As a result, the earth terminal provided on the connector so as to connect the connector to the circuit substrate is connected directly to the conductive frame, so that the circuit substrate is surely grounded, thereby more efficiently shutting out radiation and an external noise.

Further, it is preferable to arrange the receiver of the present invention so that a plug connected to the earthing conductor of the cable is provided on the cable so as to be positioned in an end connected to the connector, and the connection section of the conductive frame is connected to the plug.

As a result, the plug is formed on the cable so as to be positioned in an end connected to the connector, and the connection section of the conductive frame is connected to the plug. Thus, it is possible to suppress a possibility that the cable comes into contact with the conductive frame and is damaged in being plugged off/in. Further, it is possible to more surely and stably realize the connection.

Further, it is preferable to arrange the receiver of the present invention so that the connection section of the conductive frame has a pressure section whose elasticity causes the pressure section to be pressed against the earthing conductor of the cable.

As a result, the connection section of the conductive frame presses the cable due to its elasticity so as to support the cable. According to the arrangement, the cable can be stably in contact with the connection section of the conductive frame in plugging out/in the cable.

Further, it is preferable to arrange the receiver of the present invention so that: the circuit substrate is capable of inputting a high frequency signal from its outside and outputting the high frequency signal from its inside, and one of the connectors is provided so as to allow connection with one of the cables which inputs the high frequency signal and other one of the connectors is provided so as to allow connection with other one of the cables which outputs the high frequency signal, and the conductive frame includes the openings and the connection sections so that one of the openings and one of the connection sections correspond to said one of the cables which inputs the high frequency signal and other one of the openings and other one of the connection sections correspond to said other one of the cables which outputs the high frequency signal.

Further, in order to solve the foregoing problems, a multiple receiver apparatus of the present invention includes a plurality of receivers each of which is the receiver described above, wherein a connector provided on a first receiver so as to output the high frequency signal and a connector provided on a second receiver so as to input the high frequency signal are connected to each other by the cable.

According to the arrangement, in each receiver, the earthing conductor of the circuit substrate provided inside the conductive frame is connected to the conductive frame by the cable having the earthing conductor, and the plurality of receivers are connected to each other by the cable.

That is, grounding potentials can be kept the same in the circuit substrate, the conductive frame, and the earthing conductor of the cable, and grounding potentials can be kept the same between the receivers. Thus, it is possible to more effectively shut out radiation and an external noise.

Further, the receiving signal line of the receiver is connected directly to the circuit substrate provided inside the receiver, so that it is possible to reduce a size of the receiver.

Note that, as to the receiver and the multiple receiver apparatus of the present invention, the aforementioned receiver can constitute a television, a video cassette recorder, or a set top box.

As described above, according to the present invention, a receiver covered by a chassis is arranged so that an earth terminal of a receiving circuit substrate provided inside the receiver is connected to the chassis by an earthing conductor of a signal receiving cable with a short distance, so that it is possible to reduce a size of a receiving module and to more effectively shut out radiation and an external noise. Thus, the present invention is applicable to a field for manufacturing a tuner or various kinds of receiver represented by a television, a video cassette recorder, and a set top box connected to a television so as to allow reception of various kinds of information service and for manufacturing parts thereof.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A receiver, including: a conductive frame; and a circuit substrate which is provided inside the conductive frame and allows a high frequency signal to flow therein, one or more cables each of which has one or more earthing conductors provided around a signal line being connected to the circuit substrate,
said receiver comprising:
one or more connectors provided on the circuit substrate so as to allow connection with the cable; and
one or more connection sections respectively provided on one or more openings, each of which is provided in the conductive frame and allows the cable to pass therethrough, so that the connection section is in contact with the earthing conductors of the cable connected to the connector so as to connect the earthing conductors to the conductive frame, wherein
the conductive frame and an earthing conductor of the circuit substrate are connectable via the earthing conductors extending from the connection section to the connector.

2. The receiver as set forth in claim 1, wherein the conductive frame serves as a chassis.

3. The receiver as set forth in claim 1, wherein the conductive frame includes a chassis and a shielding member provided outside the chassis and electrically connected to the chassis, and the connection section is formed on the shielding member.

4. The receiver as set forth in claim 1, wherein:
the circuit substrate is capable of inputting a high frequency signal from its outside and outputting the high frequency signal from its inside, and
one of the connectors is provided so as to allow connection with one of the cables which inputs the high frequency signal and other one of the connectors is provided so as to allow connection with other one of the cables which outputs the high frequency signal, and
the conductive frame includes the openings and the connection sections so that one of the openings and one of the connection sections correspond to said one of the cables which inputs the high frequency signal and other one of the openings and other one of the connection sections correspond to said other one of the cables which outputs the high frequency signal.

5. The receiver as set forth in claim 1, wherein an earth terminal provided on the connector so as to allow connection of the connector and the circuit substrate is extended and is connected to the conductive frame.

6. The receiver as set forth in claim 1, wherein a plug connected to the earthing conductor of the cable is provided on the cable so as to be positioned in an end connected to the connector, and the connection section of the conductive frame is connected to the plug.

7. The receiver as set forth in claim 1, wherein the connection section of the conductive frame has a pressure section whose elasticity causes the pressure section to be pressed against the earthing conductor of the cable.

8. A multiple receiver apparatus, comprising a plurality of receivers each of which includes: a conductive frame; and a circuit substrate which is provided inside the conductive frame and allows a high frequency signal to flow therein, one or more cables each of which has one or more earthing conductors provided around a signal line being connected to the circuit substrate, each of said receivers including: one or more connectors provided on the circuit substrate so as to allow connection with the cable; and one or more connection sections respectively provided on one or more openings, each of which is provided in the conductive frames and allows the cable to pass therethrough, so that the connection section is in contact with the earthing conductors of the cable connected to the connector so as to connect the earthing conductors to the conductive frame, wherein the conductive frame and an earthing conductor of the circuit substrate are connectable via the earthing conductors extending from the connection section to the connector, and the circuit substrate is capable of inputting a high frequency signal from its outside and outputting the high frequency signal from its inside, and one of the connectors is provided so as to allow connection with one of the cables which inputs the high frequency signal and other one of the connectors is provided so as to allow connection with other one of the cables which outputs the high frequency signal, and the conductive frame includes the openings and the connection sections so that one of the openings and one of the connection sections correspond to said one of the cables which inputs the high frequency signal and other one of the openings and other one of the connection sections correspond to said other one of the cables which outputs the high frequency signal, and
a connector provided on a first receiver so as to output the high frequency signal and a connector provided on a second receiver so as to input the high frequency signal are connected to each other by the cable.
